(19) United States
(12) Patent Application Publication
(10) Pub. No.: US 2002/0149459 A1
(43) Pub. Date: Oct. 17, 2002

(54) Foil wound low profile L-T power processor

(75) Inventor: Willem G. Odendaal, Yorktown Heights, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/835,019

(22) Filed: Apr. 13, 2001

(51) Int. Cl. H01F 27/28

(52) U.S. Cl. 336/182

(57) ABSTRACT

The present invention provides a foil wound low profile power L-T processor. A magnetic winding is disposed within a core. The magnetic winding comprises concentric tape windings having at least one terminal and separated by insulating space. The tape windings can be made of conductive foil and insulation film wound together in a spiral pattern. The magnetic winding can have a center aperture in which a non-magnetic and non-conductive center post can be disposed. The center post can also be divided into portions with a combined length less than the length of the center aperture to form an air gap within the center aperture.

### TECHNICAL FIELD

The technical field of this disclosure is inductor devices, particularly, a foil wound low profile power processor having inductor and transformer characteristics.

### BACKGROUND OF THE INVENTION

There has been an aggressive pursuit after lower profile packages for power electronic circuits and components over recent years. This has lead to unconventional designs both in high and low power applications of switching power electronic circuitry. Although low profile is essential in some applications where flatness of the power supply complements the main product features, it has also found a niche in many other applications as a secondary design objective to improve cost and performance. Other related developments, such as integrated power circuits, modularization, standardization in power electronics, power electronic building blocks and distributed power systems, are fueling the evolution of low profile packaging technologies.

Often misunderstood, however, is that striving for low profile with the current materials and manufacturing technologies involves certain fundamental trade-offs. From a purely electromagnetic perspective, fiat power processing components do not utilize materials as well as box-type structures do in general. This means that a flattened structure will require a larger volume and an even more substantial footprint area to perform the same function.

Present pure planar power devices use rectangular foil alternating with rectangular insulating material, arranged in a stack. The insulating material typically has the undesired characteristic of low thermal conductivity accompanying the desired characteristic of low electrical conductivity. The insulating material lies in the primary heat flow path along the direction of the stack and impedes heat transfer. The rectangular shape precludes efficient conductive heat flow along the foil, because the center of the rectangle is too far from any heat sink. These factors can lead to high temperatures in the center of the device.

Low eddy current losses and design flexibility are achievable by using litz-wire, but litz-wire windings suffer from several disadvantages. Besides being expensive and difficult to work with, litz wire also inhibits higher winding packing densities due to the amount of insulation involved. As a result, litz-wound components often run the risk of developing hot-spot temperatures inside the windings.

The size and weight of power conversion devices are governed by the size and weight of the passive components, i.e., capacitors, transformers, and inductors. A greater number of passive components not only increases the size and weight, but also increases the cost and manufacturing complexity.

It would be desirable to have a foil wound low profile L-T power processor that would overcome the above disadvantages.

### SUMMARY OF THE INVENTION

One aspect of the present invention provides a foil wound low profile power L-T processor with low profile packaging.

Another aspect of the present invention provides a foil wound low profile power L-T processor operating at a high power density.

Another aspect of the present invention provides a foil wound low profile power L-T processor with superior heat transfer to avoid hot spots.

Another aspect of the present invention provides a foil wound low profile power L-T processor integrating the inductive and transformer characteristics to reduce the number of passive components.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 shows a perspective view of a prototype foil wound low profile power L-T processor made in accordance with the present invention;

FIG. 2 shows a magnetic winding for a foil wound low profile power L-T processor made in accordance with the present invention;

FIG. 3 shows a schematic cross section of the foil windings for a foil wound low profile power L-T processor made in accordance with the present invention;

FIG. 4 shows a top view of a foil wound low profile power L-T processor made in accordance with the method of the present invention; and

FIG. 5 shows cross-sectional view for a foil wound low profile power L-T processor made in accordance with the present invention.

### DESCRIPTION OF THE PRESENTLY PREFERRED EMBODIMENTS

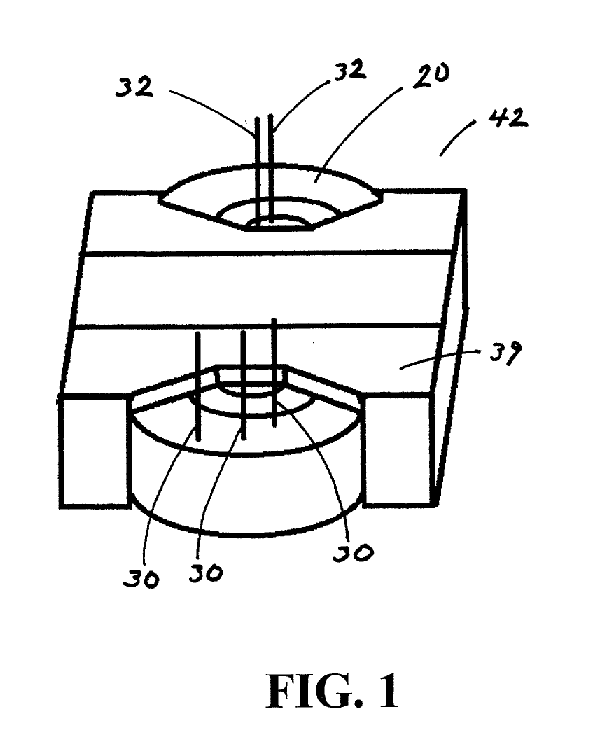

FIG. 1 shows a perspective view of a prototype foil wound low profile power L-T processor. The power processor 42 comprises a magnetic winding 20 having first winding terminals 30 and second winding terminals 32 disposed within a core 39. The power processor 42 differs from pure planar power devices by using a short cylindrical magnetic winding 20, rather than an assembly of stacked rectangular foils, and by using a core 39 that houses a cylindrical magnetic winding 20. The power processor 42 is best described as a foil-wound low-profile magnetic component. Although it is not a pure planar power device, power processor 42 maintains the low profile desirable for product design and performance. The use of a cylindrical winding allows much higher material utilization than stacked rectangular devices in terms of power density and energy density.

The power processor shown in FIG. 1 is a prototype device. Further refinements are possible. The low profile lends itself to flat packaging the power processor within a compact shell for mounting. Terminals can be brought out of the package as required for the specific application or to meet standard board layouts. The flat surface can also be provided with fins, a fan, or other cooling features. The flat profile and vertical winding are conducive to transferring heat from the power processor: the heat generated is close to the heat sink and flows vertically along the conductive foil.

Passive integration can be achieved by incorporating the leakage inductance of the power processor into the circuit design in which the power processor is used. For example, if the circuit incorporates a resonant tank, the leakage inductance of the power processor can reduce the size of the resonant inductor, or eliminate it entirely.

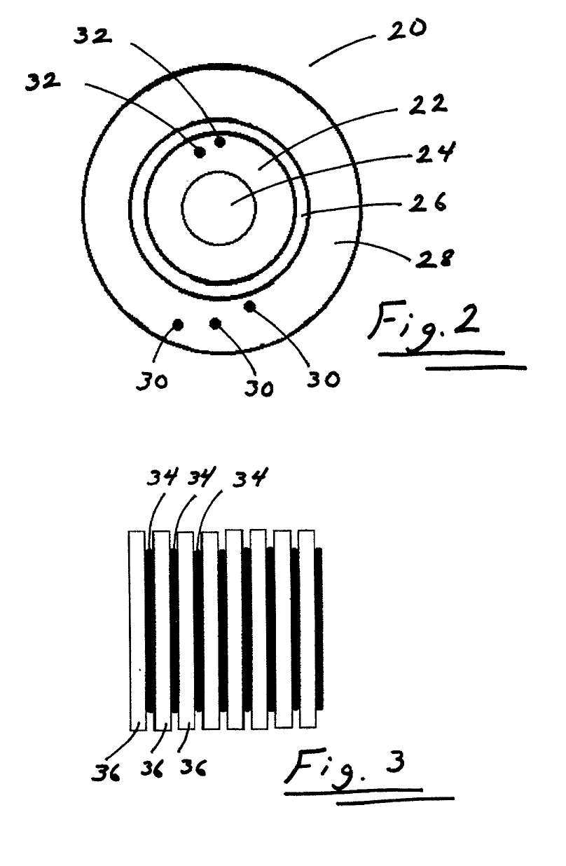

FIG. 2 illustrates a magnetic winding 20 for a foil wound low profile power L-T processor made in accordance with the present invention.

The magnetic winding 20 comprises a second tape winding 22 having a center aperture 24, an insulating space 26 concentric to the second tape winding 22, and a first tape winding 28 concentric to the insulating space 26. The first tape winding 28 and second tape winding 22 are formed of turns of electrically conductive foil with an insulation film. See FIG. 3. The tape windings can be shaped in the forms of short cylinders with the cylindrical diameter larger than its axial thickness, and are also commonly referred to as foil or barrel windings. The mechanical strength and electrical properties of magnetic winding 20 can be enhanced during fabrication with processes such as vacuum impregnation and encapsulation. Although FIG. 2 shows an embodiment with two tape windings and a single insulating space, additional concentric rings of tape windings and insulating spaces can be added to obtain specific performance requirements for specific applications.

The magnetic winding 20 can be any thickness required for the particular application. In one embodiment, the diameter is substantially larger than the axial length, creating a vertical winding. In another embodiment, the windings can have a ratio of the foil winding diameter to the foil winding thickness of greater than or equal to 10:1, which is generally considered the ratio for planar or substantially low profile components. The low profile is desirable for circuit board mounting and heat transfer.

The various tape windings can be selected as the primary or secondary windings depending on the desired performance characteristics and application. If more than two tape windings are used, the additional windings can be disposed at various diameters of the magnetic winding 20 and act as tertiary, quaternary, etc. windings. The diameters of the tape windings with respect to each other control the leakage flux associated with each tape winding. Hence, if the second tape winding 22 acts as the primary winding and the first tape winding 28 acts as the secondary winding, the leakage inductance associated with each tape winding will be quite different, but controllable, compared to the case where the roles are reversed. That is, when the secondary winding is wound on the inside of the primary winding. In general, the tape winding furthest from the center will have the higher value of primary referred leakage inductance.

The insulating space 26 can be filled with turns of a polymer insulating material such as polyethylene terephthalate (PET) film or Mylar® brand polyester film made by DuPont, or can be fabricated as a single piece of insulating material. The thermal resistance of the insulating material can be minimized to achieve low thermal gradients from the inside to the outside of the power processor, providing high thermal stability. The radial thickness of the insulating space 26 controls the amount of integrated leakage inductance, i.e., the fraction of magnetic energy stored. The total leakage inductance increases as the radial thickness of the insulating space 26 increases.

The first tape winding 28 and second tape winding 22 are provided with first winding terminals 30 and second winding terminals 32, respectively. The winding terminals provide the electrical connections between the power processor and outside devices. The winding terminals can be made of any conductive material compatible with the manufacturing process and the surrounding materials, and in various embodiments, can be made of copper, gold, silver, or aluminum. The winding terminals are in electrical contact with individual turns of the tape winding's electrically conductive foil and can be welded or press fit in place. The radial location of the winding terminals is selected to achieve varied operating output characteristics during operation, such as varying voltages. Multiple winding terminals can be used to provide multiple taps.

FIG. 3 shows a schematic cross section of the foil windings for a foil wound low profile power L-T processor. Long strips of electrically conductive foil 34 and insulation film 36 are wound about a common axis to form alternating layers of conductive foil 34 and insulation film 36. Each turn of the conductive foil 34 is insulated from the next turn by the insulation film 36, which is slightly wider than the conductive foil 34. The extra width of the insulation film 36 prevents shorting one turn of the conductive foil 34 to the next, and can be achieved by the initial selection of relative widths between the insulation film 36 and the conductive foil 34, or by etching the magnetic winding 20 to reduce the width of the conductive foil 34 after the magnetic winding 20 is wound.

In one embodiment, the conductive foil 34 can be copper and the insulation film 36 can be a polymer, such as polyethylene terephthalate (PET) film or Mylar® brand polyester film. In other embodiments, the conductive foil 34 can be made of gold, silver, or aluminum. Different materials of different thickness can be selected to meet the desired performance and will be well understood by those skilled in the art. The thickness of the conductive foil 34 can be small compared to the skin depth at the design frequency. If multiple concentric tape windings are used, different conductive foil thicknesses can be used for each winding. In an alternate embodiment, several layers of foil can be wound in parallel for each turn of insulation film 36, so that the conductive foil 34 comprises several layers of foil.

The orientation of the conductive foil 34 and insulation film 36 in the power processor is suited to efficient heat transfer. Heat flows along the narrow width of the conductive foil to the core, which acts as a heat sink. This avoids high temperatures in the center of the magnetic winding. In pure planar power devices, which have stacks of rectangular foil alternating with insulating material, the insulating material in the heat flow path restricts heat transfer. The insulation film in the power processor of the present invention lies along the direction of heat flow. This provides better heat transfer from the magnetic winding.

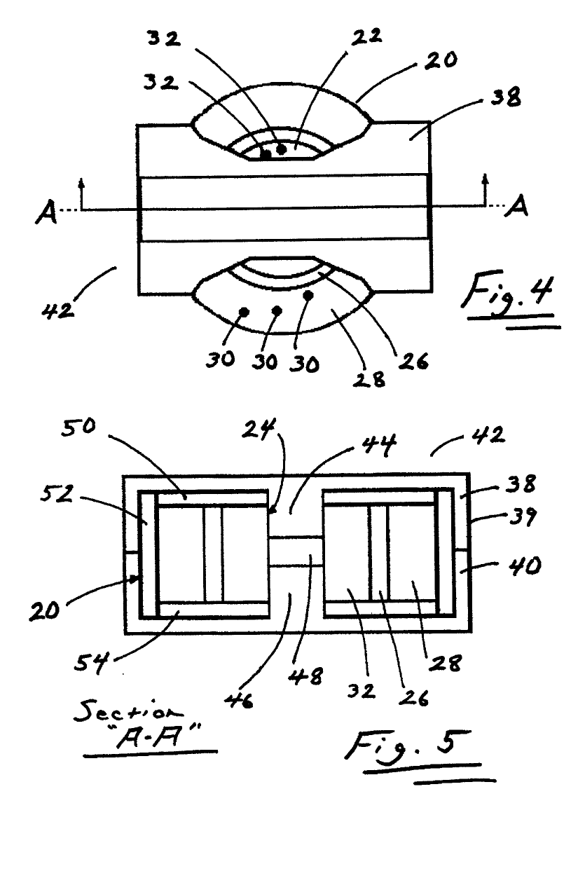

FIG. 4, in which like elements share like reference characters with FIG. 2, shows a top view of a foil wound low profile power L-T processor. First half core 38 and second half core 40 (shown in FIG. 5) enclose the magnetic winding 20 to form power processor 42. The core halves can be made of materials typically used for transformer cores, such as ferrite. The core can be any shape suited to be generally disposed about the magnetic winding 20 and to provide passage for the winding terminals. Viewed along the axis of the magnetic winding 20, the core shape can be rectangular or cruciform with various cutouts for the winding terminals. A center post for disposition within the magnetic winding 20 can be included or omitted. The core geometry can be an substantial alteration of standard configurations, such as PQ, RM, or EQ core designs, flattened to allow for the low profile of the magnetic winding 20 and with different relative dimensions.

FIG. 5, in which like elements share like reference characters with FIG. 4, shows cross-sectional view A-A from FIG. 4 for a foil wound low profile power L-T processor. Core 39 comprises the first half core 38 and the second half core 40. First center post 44 of the first half core 38 and second center post 46 of the second half core 40 pass through the center aperture 24 of the magnetic winding 20. In one embodiment, the combined length of first center post 44 and second center post 46 is shorter than the thickness of the magnetic winding 20 plus insulators, so an air gap 48 is formed between the center posts in the center aperture 24. The center posts can be made of non-magnetic, non-conductive materials. The air gap 48 and non-magnetic center posts reduce the leakage inductance of the second tape winding 22 nearest the center of the magnetic winding 20.

First insulator 50, edge insulator 52, and second insulator 54 fill the space between magnetic winding 20 and the core. The thicknesses of the first insulator 50, edge insulator 52, and second insulator 54 control the size of integrated leakage inductance, i.e., the fraction of magnetic energy that is stored. The materials for the insulators are selected for high electrical resistance and low thermal resistance. The low thermal resistance of the insulators helps achieve low thermal gradients from the inside to the outside of the power processor, providing high thermal stability. Possible materials for the insulators are air, thermally conductive pads, or resin based potting material.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A foil wound low profile power L-T processor comprising:
a magnetic winding comprising a second tape winding, an insulating space disposed about and concentric to the second tape winding, and a first tape winding disposed about and concentric to the insulating space;
at least one first winding terminal electrically connected to the first tape winding;
at least one second winding terminal electrically connected to the second tape winding; and
a core disposed about and operatively coupled to the magnetic winding.

2. The foil wound low profile power L-T processor of claim 1 wherein the diameter of the magnetic winding is substantially larger than the thickness of the magnetic winding.

3. The foil wound low profile power L-T processor of claim 1 wherein the ratio of the diameter of the magnetic winding to the thickness of the magnetic winding is greater than or equal to 10:1.

4. The foil wound low profile power L-T processor of claim 1 wherein the first tape winding further comprises conductive foil and insulation film wound in a spiral pattern.

5. The foil wound low profile power L-T processor of claim 4 wherein the conductive foil is selected from the group consisting of copper foil, gold foil, silver foil, and aluminum foil.

6. The foil wound low profile power L-T processor of claim 4 wherein the conductive foil further comprises layers of foil.

7. The foil wound low profile power L-T processor of claim 4 wherein the insulation film is a polymer film.

8. The foil wound low profile power L-T processor of claim 7 wherein the polymer film is selected from the group consisting of polyethylene terephthalate film and polyester film.

9. The foil wound low profile power L-T processor of claim 4 wherein the first tape winding further comprises a plurality of concentric rings with insulating space between each pair of the concentric rings, the concentric rings comprising conductive foil and insulation film wound in a spiral pattern.

10. The foil wound low profile power L-T processor of claim 1 wherein the second tape winding further comprises conductive foil and insulation film wound in a spiral pattern.

11. The foil wound low profile power L-T processor of claim 10 wherein the conductive foil is selected from the group consisting of copper foil, gold foil, silver foil, and aluminum foil.

12. The foil wound low profile power L-T processor of claim 10 wherein the conductive foil further comprises layers of foil.

13. The foil wound low profile power L-T processor of claim 10 wherein the insulation film is a polymer film.

14. The foil wound low profile power L-T processor of claim 13 wherein the polymer film is selected from the group consisting of polyethylene terephthalate film and polyester film.

15. The foil wound low profile power L-T processor of claim 1 further comprising a plurality of the first winding terminals electrically connected to the first tape winding.

16. The foil wound low profile power L-T processor of claim 1 further comprising a plurality of the second winding terminals electrically connected to the second tape winding.

17. The foil wound low profile power L-T processor of claim 1 wherein the insulating space is a polymer.

18. The foil wound low profile power L-T processor of claim 17 wherein the polymer is selected from the group consisting of polyethylene terephthalate film and polyester.

19. The foil wound low profile power L-T processor of claim 1 wherein the second tape winding forms a center aperture along the axis of the second tape winding.

20. The foil wound low profile power L-T processor of claim 19 wherein the center aperture has a substantially circular cross section.

21. The foil wound low profile power L-T processor of claim 19 wherein the core further comprises a center post disposed within the center aperture of the second tape winding.

22. The foil wound low profile power L-T processor of claim 21 wherein the center post is non-magnetic and non-conductive.

23. The foil wound low profile power L-T processor of claim 21 wherein the center post further comprises a first center post and a second center post.

24. The foil wound low profile power L-T processor of claim 23 wherein the combined length of the first center post and the second center post is less than the length of the center aperture so that an air gap is formed between the first center post and the second center post within the center aperture.

25. The foil wound low profile power L-T processor of claim 1 wherein insulators are disposed between the magnetic winding and the core.

26. The foil wound low profile power L-T processor of claim 1 wherein the first tape winding is the primary winding and the second tape winding is the secondary winding.

27. The foil wound low profile power L-T processor of claim 1 wherein the first tape winding is the secondary winding and the second tape winding is the primary winding.

28. A method for manufacturing a foil wound low profile power L-T processor comprising the steps of:
forming a second tape winding by winding conductive foil and insulation film in a spiral pattern;
forming an insulating space by winding a polymer film about the second tape winding;
forming a first tape winding by winding conductive foil and insulation film in a spiral pattern about the insulating space;
electrically connecting at least one first winding terminal to the first tape winding;
electrically connecting at least one second winding terminal to the second tape winding; and
disposing the second tape winding, the insulating space, and the first tape winding within a core.

29. A system for manufacturing a foil wound low profile power L-T processor comprising:
means for forming a second tape winding by winding conductive foil and insulation film in a spiral pattern;
means for forming an insulating space by winding a polymer film about the second tape winding;
means for forming a first tape winding by winding conductive foil and insulation film in a spiral pattern about the insulating space;
means for electrically connecting at least one first winding terminal to the first tape winding;
means for electrically connecting at least one second winding terminal to the second tape winding; and
means for disposing the second tape winding, the insulating space, and the first tape winding within a core.

30. A foil wound low profile power L-T processor comprising:
a magnetic winding comprising a second tape winding having a center aperture, an insulating space disposed about and concentric to the second tape winding, and a first tape winding disposed about and concentric to the insulating space;
at least one first winding terminal electrically connected to the first tape winding;
at least one second winding terminal electrically connected to the second tape winding; and
a core comprising a first half core having a first center post and a second half core having a second center post, wherein the first half core and the second half core are disposed on opposite sides of and operatively coupled to the magnetic winding, and the first center post and are disposed in the center aperture.

31. The foil wound low profile power L-T processor of claim 30, wherein the first center post and the second center post are non-magnetic and non-conductive.

32. The foil wound low profile power L-T processor of claim 30 wherein the combined length of the first center post and the second center post is less than the length of the center aperture so that an air gap is formed between the first center post and the second center post within the center aperture.

33. The foil wound low profile power L-T processor of claim 30 further comprising a first insulator electrically isolating the first half core from the magnetic winding, a second insulator electrically isolating the second half core from the magnetic winding, and an edge insulator electrically isolating the first half core and the second half core from the magnetic winding.

34. A foil wound low profile power L-T processor comprising:
a magnetic winding comprising a second tape winding having a center aperture, an insulating space disposed about and concentric to the second tape winding, and a first tape winding disposed about and concentric to the insulating space;
a plurality of first winding terminals electrically connected to the first tape winding;
a plurality of second winding terminals electrically connected to the second tape winding;
a first half core having a first center post, the first half core disposed about the magnetic winding with the first center post disposed in the center aperture;
a second half core having a second center post, the second half core disposed about the magnetic winding with the second center post disposed in the center aperture;
a first insulator disposed between the first half core and the magnetic winding;
a second insulator disposed between the second half core and the magnetic winding; and
an edge insulator, the edge insulator disposed between the first half core and the edge of the magnetic winding, the edge insulator further disposed between the second half core and the edge of the magnetic winding;
wherein the first center post and the second center post form an air gap in the center aperture.
